(19) United States
(12) Patent Application Publication
(10) Pub. No.: US 2017/0029670 A1
(43) Pub. Date: Feb. 2, 2017

(54) POLYOLEFIN BASED HOT MELT ADHESIVE COMPOSITION

(71) Applicant: BASELL POLIOLEFINE ITALIA S.R.L., MILANO (IT)

(72) Inventors: STEFANO SPATARO, FERRARA (IT); GIAMPAOLO PELLEGATTI, FERRARA (IT); ROBERTA MARCHINI, FERRARA (IT); STEFANO PASQUALI, FERRARA (IT)

(73) Assignee: BASELL POLIOLEFINE ITALIA S.R.L., MILANO (IT)

(21) Appl. No.: 15/039,263

(22) PCT Filed: Oct. 27, 2014
(86) PCT No.: PCT/EP2014/072950

§ 371 Date: May 25, 2016

(30) Foreign Application Priority Data
Nov. 25, 2013 (EP) 13194201.3

(51) Int. Cl. C09J 123/20

(52) U.S. Cl. CPC C09J 123/20

(57) ABSTRACT

The present disclosure generally relates to a hot melt adhesive polyolefin composition comprising a high melt flow, butene-1 copolymer suitable to be used as a glue in the paper and packaging industry, in furniture manufacturing, e.g. for edgebands, square edges and softforming, for paneling in high moisture environments, and as a glue in tufted or needle punched carpets.

The present disclosure relates to a hot melt adhesive polyolefin composition comprising an high fluidity butene-1 copolymer. The polyolefin composition comprises both thermoplastic and elastomeric polyolefins. It also relates to articles prepared with the adhesive polyolefin composition.

The adhesive composition of the present disclosure can be used in several fields such as in paper and packaging industry, in furniture manufacturing, e.g. for edgebands, square edges and softforming, and for paneling in high moisture environments.

It can be used as a glue in tufted or needle punched carpets, the fibers of which are fixed to the primary carpet backing by the hot melt adhesive composition.

### BACKGROUND OF THE INVENTION

Hot melt adhesive compositions comprising thermoplastic polyolefins are known in the art. Examples of hot melt adhesive compositions are described in published European Patent Application No. 671431 (assigned to Himont Incorporated). The compositions described therein are suitable for producing films and for bonding the layers comprising the films to each other.

One of the main drawbacks shown by the above hot melt composition is that, although the exemplified compositions generally have a low viscosity, i.e. about 10,000 mPa·sec, the methods used to obtain the viscosity is disadvantageous. The high amount of peroxides used makes the compositions less suitable and economical for industrial applications. Also, an unpleasant odor often characterizes polymer products obtained by the use of peroxides in production processes, e.g. in food packaging applications, requiring lower or absent odor.

Low molecular weight polyolefins are known, e.g. from EP Pat. Doc. 0737233 A1, as components of hot melt adhesive, polyester-based compositions to raise and lower Tg (glass transition temperature) and RB SP (ring and ball softening point).

In U.S. Pat. App. Pub. No. 2008190541, an adhesive system based on a non-reactive thermoplastic adhesive melt is disclosed. The adhesive melt (A) contains a mixture of at least two metallocene-catalyst produced copolymers which are different from each other, and which are based on at least two alpha-olefins, where the copolymers of the mixture, which are different from each other, have different melt indices (MFIs). The low melt index component is essential to obtain the balance of properties for hot melt adhesive. In addition, the elongation at break of the adhesive system (hot melt adhesive) suitable for use in the wood and furniture industry is generally in the range of 200-1200%, as determined according to DIN 53455, after coating or application and 24-hour storage in a normal climate (50% relative humidity, 20° C.).

Therefore a need exists for polyolefin compositions for hot melt adhesives, with a low viscosity but without the above mentioned drawbacks due to the high amount of peroxides, that show good adhesive properties and high elongation.

### SUMMARY OF THE INVENTION

The present disclosure generally relates to a hot melt adhesive polyolefin composition comprising thermoplastic and elastomeric polyolefins, showing good adhesive properties and an excellent balance of low viscosity and high elongation.

In some embodiments, the hot melt adhesive polyolefin composition according to the present disclosure comprises:

(A) a high melt flow butene-1 copolymer containing from 2 to 6% by weight of ethylene derived units, having a melt flow rate (MFR) measured according to ISO 1133 (190° C., 2.16 kg) ranging from 200 to 1500 g/10 min; an intrinsic viscosity (IV) measured in tetrahydronaphthalene (THN) at 135° C. lower than 0.8 dl/g;
(B) optionally at least one additional polymer; and
(C) optionally at least one resin, and
(D) optionally at least a material selected from waxes, oils or mixture thereof.

The compositions of the present disclosure do not present the above mentioned drawbacks of the state of the art, as the processed high melt flow butene-1 copolymer exhibits high melt flow and good adhesion properties.

Another advantage of the hot melt composition of the present disclosure relates its rheological and thermal properties that beneficially help to spread the adhesive in a more efficient way. For instance, a small but measurable XR crystallinity (measured via X-ray) combined with very slow crystallization kinetics (Tc of component (A) is not even measurable according to the method specified in the examples) produces a definite advantage for hot melt adhesive applications requiring long times for the operative adhesion steps.

### DETAILED DESCRIPTION OF THE INVENTION

An object of the present disclosure is a hot melt adhesive polyolefin composition comprising:
(A) a high melt flow butene-1 copolymer containing from 2 to 6% by weight of derived units of ethylene, including from 2.5 to 4.5 by weight, having a melt flow rate (MFR) measured according to ISO 1133 (190° C., 2.16 kg) ranging from 200 to 1500 g/10 min, including from 500 to 900 g/10 min and from 550 to 800 g/10 min.

In some embodiments, the butene-1 copolymer component (A) has at least one of the following features:

a) distribution of molecular weight (Mw/Mn) lower than 4; including lower than 3 and lower than 2.5; wherein butene-1 copolymers having an Mw equal to or higher than 60,000 and an Mn equal to or greater than 30,000, may be used.
b) an intrinsic viscosity (IV) measured in tetrahydronaphthalene (THN) at 135° C. of lower than 0.8 dl/g, such as between 0.2 dl/g and 0.6 dl/g; between 0.3 dl/g and 0.6 dl/g and between 0.4 dl/g and 0.5 dl/g;
c) a melting point lower than 110° C.; such as lower than 100° C. and lower than 90° C.; including melting points (TmII) measured cancelling the thermal history of the butene-1 copolymer component (A) that are lower than 80° C.
d) isotactic pentads (mmmm) measured with ¹³C-NMR operating at 100.61 MHz higher than 90%; such as higher than 95%;
e) 4,1 insertions not detectable with ¹³C-NMR operating at 100.61 MHz;
g) a yellowness index lower than 0; including between 0 and −10 and between −1 and −5.

In some embodiments, the amount of component (A) is from 5 to 85% by weight, including 15-60% by weight and 15-45% by weight of the composition. Component (A) can be obtained according to the process and catalyst as described in WO 2004/099269 and WO 2006/045687, herein incorporated by reference. As explained in WO 2006/045687, hydrogen can be advantageously used as molecular weight regulator and as an activator of the catalyst system. This process, combined with ethylene comonomer as explained in WO 2004/099269, can provide 1-butene ethylene copolymers endowed with very low melting points.

The polymerization process of the present disclosure can be carried out in one or more reactors connected in series, as explained in WO 2004/099269, and can be carried out in liquid phase, optionally in the presence of an inert hydrocarbon solvent or in gas phase. The hydrocarbon solvent can be either aromatic (such as toluene) or aliphatic (such as propane, hexane, heptane, isobutane, cyclohexane, 2,2,4-trimethylpentane and isododecane). In certain embodiments, the polymerization process of the present disclosure is carried out by using liquid 1-butene as polymerization medium. In some embodiments, the polymerization temperature ranges from 20° C. to 150° C., from 50° C. to 90° C., and from 68° C. to 82° C.

In further embodiments, the concentration of hydrogen used during the polymerization reaction liquid phase (mol ppm H2/(C4) bulk) is from 2000 ppm to 3000 ppm, including between 2400 ppm and 2700 ppm.

In certain embodiments, the amount of ethylene in the liquid phase (% wt C2/C4) is between 0.5 and 1.5% by weight, including from 0.6 to 1.8% by weight.

In some embodiments, the hot melt adhesive polyolefin composition according to the present disclosure further comprises:
(B) at least one optional additional polymer, selected from the group of amorphous poly-alpha-olefins, thermoplastic polyurethanes, ethylene/(meth)acrylate copolymers, and ethylene/vinyl acetate copolymers, as well mixtures thereof.
   The amount of component (B) in the hot melt adhesive composition (adhesive system), in accordance with embodiments of the present disclosure, can also vary within broad ranges. In general, the hot melt adhesive contains the additional polymer (B) in quantities of 0.001-30 wt %, such as 0.01-25 wt %, and 1-25 wt % with respect to the hot melt adhesive composition. Depending on the application or the individual case, it may be beneficial in some embodiments to deviate from the above-mentioned quantity ranges.

The hot melt adhesive polyolefin composition according to the present disclosure further comprises:
(C) optionally at least one additional resin material different from the polymeric resin components (A) and (B), selected from aliphatic hydrocarbon resin, terpene/phenolic resin, polyterpenes, rosin, rosin esters and derivatives/blends thereof;
   In certain embodiments, the amount of the optional component (C) can range from 10 to 75% by weight, such as 10-40% by weight of the hot melt adhesive composition.

In additional embodiments, the hot melt adhesive polyolefin composition further comprises:
(D) optionally at least a material selected from waxes, oils or mixture thereof. Waxes and oils can be mineral, paraffinic or naphtalenic waxes or oils.
   The amount of the optional component (D) can vary from 0.001 to 50% by weight, including 1-30% by weight, of the hot melt adhesive composition.

In certain embodiments, the composition according to the present disclosure has a viscosity from 7,000 to less than 500,000 mPa·sec, according to ASTM D 3236-73, at 190° C., including 10,000 to 80,000 mPa·sec.

In further embodiments, one feature of butene-1 copolymer, component (A), is present as a visible (detectable) amount of crystalline form III. Crystalline form III has been detected on component (A) via X-ray diffraction as described in the Journal of Polymer Science Part B: Polymer Letters Volume 1, Issue 11, pages 587-591, November 1963; and Macromolecules, Vol. 35, No. 7, 2002.

### EXAMPLES

The following examples are given for illustrating but not limiting purposes. The following analytical methods are used to determine the properties reported in the description and in the examples.

The intrinsic viscosity (I.V.) was measured in tetrahydronaphtalene (THN) at 135° C.

The thermal properties (melting temperatures and enthalpies) were determined by Differential Scanning calorimetry (D.S.C.) on a PerkinElmer DSC-7 instrument. The melting temperatures of butene-1 homo- and co-polymers were determined according to the following method:
TmII (melting temperature(s) measured in second heating run): a weighted sample (5-10 mg) obtained from the polymerization was sealed into aluminum pans and heated at 200° C. with a scanning speed corresponding to 10° C./minute. The sample was kept at 200° C. for 5 minutes to allow a complete melting of all the crystallites thus cancelling the thermal history of the sample. Successively, after cooling to −20° C. with a scanning speed corresponding to 10° C./minute, the peak temperature was taken as crystallization temperature (Tc). After standing 5 minutes at −20° C., the sample was heated for the second time at 200° C. with a scanning speed corresponding to 10° C./min. In this second heating run, the peak temperature(s) measured were marked as (TmII) and the area under the peak (or peaks) as the global melting enthalpy (DH TmII).
The melting enthalpy and the melting temperature were measured after aging (without cancelling the thermal history) as follows by using Differential Scanning calorimetry (D.S.C.) on a PerkinElmer DSC-7 instrument. A weighted sample (5-10 mg) obtained from the polymerization was sealed into aluminum pans and heated at 200° C. with a scanning speed corresponding to 10° C./minute. The sample was kept at 200° C. for 5 minutes to allow a complete melting of all the crystallites. The sample was then stored for 10 days at room temperature. After 10 days the sample was subjected to DSC, it was cooled to −20° C., and then it was heated at 200° C. with a scanning speed corresponding to 10° C./min. In this heating run, the peak temperature (or temperatures when more than one peak was present) were recorded as the melting temperatures (TmI), and the area under the peak (or peaks) as the global melting enthalpy after 10 days (DH TmI).

Molecular weight parameters (Mn, Mw and Mz and IV_{gpc}) values and molecular weight distributions (Mw/Mn) for all the samples were measured using a Waters 150 C ALC/GPC instrument (Waters, Milford, Mass., USA) equipped with four mixed-gel columns with PLgel 20 μm Mixed-A LS (Polymer Laboratories, Church Stretton, United Kingdom). The dimensions of the columns were 300×7.8 mm. The solvent used was TCB and the flow rate was kept at 1.0 mL/min. Solution concentrations were 0.1 g/dL in 1,2,4 trichlorobenzene (TCB). 0.1 g/L of 2,6-di-t-butyl-4-methyl phenol (BHT) was added to prevent degradation and the injection volume was 300 μL. All the measurements were carried out at 135° C. GPC calibration is complex, as no well-characterized, narrow molecular weight distribution standard reference materials are available for 1-butene polymers. Thus, a universal calibration curve was obtained using 12 polystyrene standard samples with molecular weights ranging from 580 to Ser. No. 13/200,000. It was assumed that the K values of the Mark-Houwink relationship were: KPS=1.21×10⁻⁴, dL/g and KPB=1.78×10⁻⁴ dL/g for polystyrene and poly-1-butene, respectively. The Mark-Houwink exponents a were assumed to be 0.706 for polystyrene and 0.725 for poly-1-butene. Even though, in this approach, the molecular parameters obtained were only an estimate of the hydrodynamic volume of each chain, they allowed a relative comparison to be made.

NMR Analysis.

¹³C-NMR spectra were acquired on a DPX-400 spectrometer operating at 100.61 MHz in Fourier transform mode at 120° C. The samples were dissolved in 1,1,2,2-tetrachloroethane-d2 at 120° C. with a 8% wt/v concentration. Each spectrum was acquired with a 90° pulse, 15 seconds of delay between pulses and CPD (waltz16) to remove ¹H-¹³C coupling. About 3000 transients were stored in 32K data points using a spectral window of 6000 Hz. The isotacticity of metallocene-made PB is measured by ¹³C NMR, and is defined as the relative intensity of the mmmm pentad peak of the diagnostic methylene of the ethyl branch. This peak at 27.73 ppm was used as internal reference. Pentad assignments are given according to Macromolecules, 1992, 25, 6814-6817.

The side chain methylene region of PB spectrum was fitted using the routine for deconvolution included in the Bruker WIN-NMR program. The mmmm pentad and the pentads related to the single unit error (mmmr, mmrr and mrrm) were fitted using Lorenzian lineshapes, allowing the program to change the intensity and the width of the lines. As a result, the relative intensities of those signals were obtained. These results were used for the statistical modelling of pentad distributions using an enantiomorphic site model, in order to obtain the complete pentad distribution, from which the triad distribution is derived.
Assignments of 4,1 insertion were made according to V. Busico, R. Cipullo, A. Borriello, Macromol. Rapid. Commun. 1995, 16, 269-274. The measurement of comonomer content was also made via NMR after appropriate calibration.

Melt flow rate was measured according to ISO 1133 (190° C., 2.16 kg) on the butene-1 component (A).

Comonomer content (% wt) was measured via IR spectroscopy, where not differently specified, after appropriate calibration.

Flexural modulus, was measured according to ISO 178.

Tensile properties (strength at yield, elongation at break, strength at break and elongation at yield) have been measured (strain and stress) according to ISO 527-1.

Specimens for tensile and flexural tests were cut from compression molding plaques pressed at 200° C. and aged via autoclave at RT for 10′ at 2 kbar. Specimen thickness was 4 mm for flexural modulus, and 2 mm for tensile tests.

Yellowness index was measured according to ASTM D1925.

Solubility in Xylene: Xylene soluble and insoluble fractions (% wt) were determined as follows:

2.5 g of polymer composition and 250 cm³ of O-xylene are introduced in a glass flask equipped with a refrigerator and a magnetic stirrer. The temperature is raised in 30 minutes up to the boiling point of the solvent. The resulting clear solution is then kept under reflux and stirring for an additional 30 minutes. The closed flask is then cooled to 100° C. in air for 10 to 15 minutes under stirring and then kept for 30 minutes in a thermostatic water bath at 0° C. for 60 minutes. The resulting solid is filtered on quick filtering paper at 0° C. 100 cm³ of the filtered liquid is poured in a previously weighed aluminum container, which is heated on a heating plate under nitrogen flow, to remove the solvent by evaporation. The weight percentage of polymer soluble in xylene (XS) at room temperature (25° C.) is then calculated.

Hardness shore D: measured on compression molded plaques (thickness of 4 mm) following ISO 868.

Density: measured according to ASTM D 792-00.

X-Ray crystallinity (RX) was measured according to the following method: The instrument used to measure crystallinity is an X-ray Diffraction Powder Diffractometer (XDPD) that uses the Cu-Kα1 radiation with fixed slits and is able to collect spectra between diffraction angle 2Θ=5° and 2Θ=35°, with steps of 0.1° every 6 seconds. The samples are diskettes of about 1.5-2.5 mm of thickness and 2.5-4.0 cm of diameter made by compression molding. The diskettes are aged at room temperature (23° C.) for 96 hours. After this preparation the specimen is inserted in the XDPD sample holder. The XRPD instrument is set in order to collect the XRPD spectrum of the sample from diffraction angle 2Θ=5° to 2Θ=35°, with steps of 0.1° by using counting time of 6 seconds, until the end the final spectrum is collected.

Defining Ta as the total area between the spectrum profile and the baseline expressed in counts/sec·2Θ; and Aa as the total amorphous area expressed in counts/sec·2Θ, Ca is the total crystalline area expressed in counts/sec·2Θ.
The spectrum or diffraction pattern is analyzed in the following steps:
1) define a suitable linear baseline for the whole spectrum and calculate the total area (Ta) between the spectrum profile and the baseline;
2) define a suitable amorphous profile, along the whole spectrum, that separates the amorphous regions from the crystalline ones according to the two phase model;
3) calculate the amorphous area (Aa) as the area between the amorphous profile and the baseline;
4) calculate the crystalline area (Ca) as the area between the spectrum profile and the amorphous profile as Ca=Ta−Aa;
5) Calculate the degree of crystallinity (% Cr also marked hereinbelow as cryst tot %) of the sample using the following formula: % Cr=100×Ca/Ta

Preparation of catalyst components: Rac dimethylsilyl{(2,4,7-trimethyl-1-indenyl)-7-(2,5-dimethyl-cyclopenta[1,2-b:4,3-b′]-dithiophene)}zirconium dimethyl (A-1); was prepared according to EP Pat. Doc. 04101020.8.

Preparation of the catalytic solution: Under nitrogen atmosphere, 2390 g of a 110 g/L solution of TIBA in isododecane and 664 g of 30% wt/wt solution of MAO in toluene are loaded in a 20 L jacketed glass reactor, stirred by means of an anchor stirrer, and allowed to react at 50-55° C. for about 1 hour under stirring.

After this time, 7.09 g of metallocene A-1 is added and dissolved under stirring for about 30 minutes. The resulting solution was diluted with 1200 g of anhydrous iso-dodecane.

The final solution is discharged from the reactor into a cylinder through a filter to remove eventual solid residues.

The composition of the solution was as follows:

| | | Al/Zr | % w | Conc. |
|---|---|---|---|---|
| % w Al | % w Zr | mol ratio | toluene | g/L |
| 25.32 | 0.22 | 429 | 10 | 107 |

### EXAMPLES

Examples 1-3 according to the present disclosure and comparative examples (Comp. 1-3) are obtained as follows.

The polymerization was carried out in a stirred reactor, in which liquid butene-1 constituted the liquid medium. The catalyst system described above was injected into the reactor at a feed rate of (catalyst+alkyl) component (A), in g/h, and the polymerization was carried out in continuous mode at a polymerization temperature of (B), in ° C. The residence time was (C) min. The catalyst yield (mileage) is reported as (F), in kg/kg referred to (A), or as (F′), in kg/g, referring to the catalyst feed. Comonomer is almost immediately copolymerized (C2-“stoichiometric” feed to the reactor). Data of the examples are reported in Table 1.

TABLE 1

| | | example | | | | | |
|---|---|---|---|---|---|---|---|
| | | Comp. 1 | Comp. 2 | Comp. 3 | 1 | 2 | 3 |
| A (cat + alkyl) | g/h | 3.4 | 2.9 | 3.1 | 3.2 | 3.2 | 3.4 |
| B | ° C. | 75.0 | 75.0 | 75.0 | 75.0 | 75.0 | 75.0 |
| C | min | 150.4 | 170.3 | 145.6 | 150.0 | 138.6 | 150.3 |
| D′ | mol ppm H2/ | 2576 | 2587 | 2818 | 1821 | 1811 | 1893 |
| | (C4− + C2−) | | | | | | |
| | feed | | | | | | |
| D | mol ppm H2/ | 3624 | 3575 | 3932 | 2563 | 2581 | 2670 |
| | (C4−) bulk | | | | | | |
| E - MFR 190° | g/10 min | 1348 | 1052 | 1390 | 741 | 713 | 628 |
| 2.16 Kg - ISO 1133 | | | | | | | |
| F - Mileage | Kg/kg (ref. to | 8047 | 8163 | 8898 | 8637 | 9635 | 7856 |
| | catalyst + alkil | | | | | | |
| | feed) | | | | | | |
| F′ - Mileage | Kg/g (ref. to | 2912 | 2893 | 3219 | 3125 | 3486 | 2843 |
| | catalyst feed) | | | | | | |
| % wt C2−/C4− | feed | 0.3 | 0.3 | 0.3 | 0.8 | 1.1 | 1.4 |
| C2− in copolymer | | 1 | 1 | 1 | 2.9 | 3.9 | 4.5 |
| (IR) | | | | | | | |
| | | | no steady | | | | no steady |
| | | | state | | | | state |

The 1-butene polymer was recovered as melt from the solution and cut in pellets. The polymers obtained in Examples 1-3 and Comparative Examples 1-3 were further characterized, the results are reported in Table 2.

TABLE 2

| | | example | | | | | |
|---|---|---|---|---|---|---|---|
| | | Comp. 1 | Comp. 2 | Comp. 3 | 1 | 2 | 3 |
| MFR 190° 2.16 Kg - ISO 1133 | g/10 min | 1348 | 1052 | 1390 | 741 | 713 | 628 |
| Intrinsic Viscosity (THN) | dl/g | 0.35 | — | — | 0.43 | 0.44 | 0.45 |
| C2 IR | % | 1 | 1 | 1 | 2.9 | 3.9 | 4.5 |
| C2 NMR | % | | | | 2.7 | 3.2 | 4 |
| r1r2 | | | | | 1.61 | 1.28 | 1.21 |
| TmII* | ° C. | 80.5/85.5 | 78/84 | 80/86 | 75.6 | 71 | nd |
| DH TmII | J/g | 32 | 28 | 26 | 2.9 | 1.94 | nd |
| TmI* | ° C. | 101.7 | 87/101.6 | 103.3 | 75/88 | 57/61 | 53/66 |
| DH TmI | J/g | 65 | 49 | 65 | 34 | 27 | 22 |
| Tc | ° C. | 32 | 27 | 31 | — | — | — |
| XS | % | 7.4 | 9.7 | 10.6 | 99.9 | 99.7 | 100 |
| Density | kg/dm³ | 0.908 | 0.9077 | 0.9084 | 0.8989 | 0.8902 | 0.8895 |
| Flex Mod | MPa | 339 | 350 | 276 | 209 | 163 | 130 |
| Strength at yield | MPa | 0 | 0 | 0 | 10.4 | 7.6 | 5.6 |
| Elongation at Yield | % | 0 | 0 | 0 | 19 | 11.5 | 11.7 |
| Strength at Break | MPa | 15.6 | 18.9 | 13.7 | 17.9 | 13.1 | 10 |
| Elongation at Break | % | 8 | 18 | 6 | 390 | 401 | 403 |
| Hardness Shore D | D | 54.7 | 57 | 53.8 | 44 | 36.8 | 35.5 |
| Yellow Index | NR | 2.7 | 0.8 | 2.9 | −1.7 | −2.6 | −1.4 |
| GPC | | | | | | | |
| Ivgpc | dl/g | 0.45 | 0.47 | 0.43 | 0.53 | 0.55 | 0.61 |
| MP | | 48176 | 49858 | 44366 | 58556 | 63806 | 68053 |
| Mn | | 26445 | 26967 | 24325 | 32440 | 34490 | 39235 |
| Mv | | 48177 | 51095 | 45621 | 61301 | 65139 | 75081 |
| Mw | | 51745 | 55174 | 49172 | 66049 | 70174 | 81670 |
| Mz | | 81654 | 91119 | 79654 | 107024 | 113446 | 144110 |
| Mw/Mn | | 2 | 2 | 2 | 2 | 2 | 2.1 |
| Mz/Mw | | 1.6 | 1.7 | 1.6 | 1.6 | 1.6 | 1.8 |
| RX | h | crist tot % | | | | | |
| | 96 | | 51 | 52 | | 29 | 29 |
| | 384 | 50 | | | | | |

*When two distinct peaks were readable in the thermogram they were both reported (peakvalue₁/peakvalue₂); DH being determined integrating the overall area under the peak/s.

What is claimed is:

1. A hot melt adhesive polyolefin composition comprising:
(A) a high melt flow butene-1 copolymer containing from 2 to 6% by weight of derived units of ethylene, having a melt flow rate (MFR) measured according to ISO 1133 (190° C., 2.16 kg) ranging from 200 to 1500 g/10′;
(B) optionally at least one additional polymer component, selected from the group consisting of amorphous poly-alpha-olefins, thermoplastic polyurethanes, ethylene/(meth)acrylate copolymers, and ethylene/vinyl acetate copolymers and mixtures thereof;
(C) optionally at least one additional resin material selected from aliphatic hydrocarbon resin, terpene/phenolic resin, polyterpenes, rosin, rosin esters, derivatives thereof and mixtures thereof;
(D) optionally at least a material selected from waxes, oils or mixture thereof.

2. A hot melt adhesive polyolefin composition according to claim 1, wherein the butene-1 copolymer component (A) has a molecular weight distribution (Mw/Mn) lower than 4.

3. A hot melt adhesive polyolefin composition according to claim 1, comprising in percent by weight of the hot melt adhesive composition:
from 5 to 85% of component (A);
from 0.001-30% of component (B);
from 10 to 75% of component (C); and
from 0.001 to 50% of component (D).

4. A hot melt adhesive polyolefin composition according to claim 1 having viscosity of from 7000 to less than 500000 mPa·sec, according to ASTM D 3236-73, at 190° C.

5. A packaging industry or furniture items, comprising the hot melt adhesive polyolefin composition according to claim 1.

6. A tufted or needle punched carpets, comprising the hot melt adhesive polyolefin composition according to claim 1.
